(19) United States
(12) Patent Application Publication
(10) Pub. No.: US 2013/0101745 A1
(43) Pub. Date: Apr. 25, 2013

(54) METHOD FOR PREPARING A MULTILAYER COATING ON A SUBSTRATE SURFACE BY MEANS OFTHERMAL SPRAYING

(71) Applicants: Erick Meillot, Monts (FR); Romain Vert, Isle (FR); JoëL Toulc'hoat, Joue Les Tours (FR); Gilles Mariaux, Beynac (FR); Armelle Vardelle, Saint-Just-Le-Martel (FR)

(72) Inventors: Erick Meillot, Monts (FR); Romain Vert, Isle (FR); JoëL Toulc'hoat, Joue Les Tours (FR); Gilles Mariaux, Beynac (FR); Armelle Vardelle, Saint-Just-Le-Martel (FR)

(73) Assignee: UNIVERSITE DE LIMOGES, Limoges, Cedex (FR)

(21) Appl. No.: 13/642,807

(22) PCT Filed: Apr. 21, 2011
(86) PCT No.: PCT/EP2011/056431

§ 371 Date: Dec. 28, 2012

(30) Foreign Application Priority Data
Apr. 23, 2010 (FR) 1053144

(51) Int. Cl. C23C 4/12

(52) U.S. Cl. CPC C23C 4/12; C23C 4/127; B82Y 30/00
USPC 427/455; 427/446; 977/902

(57) ABSTRACT

A method for making a multilayer coating on a surface of a substrate by means of at least one thermal spraying method, wherein the following successive steps are carried out:
a) a first nanostructured or finely structured layer (21) of a first material is deposited on the surface of the substrate (20) by means of a thermal spraying method via a liquid route; the surface of the substrate (20) not having been subject, prior to the deposition of the first nanostructured or finely structured layer (21), to any preparation or activation treatment other than an optional cleaning treatment;
b) a second microstructured layer (22) of a second material is deposited on the first nanostructured or finely structured layer (21) by means of a thermal spraying method.

The first layer obtained in step a) is an adhesion layer aiming at optimizing the adhesion of the layer obtained in step b) without any surface preparation or activation.

### TECHNICAL FIELD

The invention relates to a method for preparing a coating on a surface of a substrate by at least one thermal spraying method.

More specifically the invention relates to a method for preparing a multilayer coating adhering onto a surface of a substrate by means of at least one thermal spraying method.

The invention in particular applies to the preparation of a thick ceramic(s) coating on a metal substrate.

The technical field of the invention may be generally defined as that of the preparation, manufacturing of a coating by thermal spraying.

### STATE OF THE PRIOR ART

Thermal projection, spraying is part of the techniques for surface treatment via a dry route. With this technique it is possible to make thick coatings, generally with a thickness from a few tens of micrometers to a few hundreds or even thousands of micrometers, of very diverse natures on just as diverse substrates or parts to be coated.

All the thermal spraying systems use a heating device in which a gas is introduced, a so-called projection, spraying, gas, used for accelerating, heating and transporting fine particles as far as the part to be coated, which particles are typically of micrometric size, i.e. generally a size from 50 to 100 micrometers. The fine particles, solid in the initial state, may be in the liquid, semi-molten, or even solid state after passing into the spraying gas.

These particles are injected into the spraying gas by means of a gas bearing them, a so-called carrier gas. The user has to have the momentum of the carrier gas and of the particles coincide with that of the spraying gas in order to allow the particles to properly penetrate the spraying gas.

The spraying gas brought to a high temperature, is thus an enthalpy and kinetic source which allows the particles to be heated up to their melting point or beyond, and to be imparted with a certain velocity.

In the following, methods via a <<conventional route>> or more simply <<conventional>> methods will designate thermal projection, spraying methods via a “dry route” which use dry micrometric powders as opposed to methods via a <<liquid route>> described below which apply suspensions of nanometric particles or solutions of precursors of these particles.

The particles projected, sprayed onto the substrate are crushed and spread out in multiple ways depending on their velocity, their molten state, their temperature, etc.

By accumulating the particles on the substrate it is possible to produce the coating by stacking these particles.

There exist many ways for producing a deposit by thermal spraying but the most currently used methods in the industry are flame-powder spraying, arc-wire spraying, supersonic or hypersonic spraying designated as <<HVOF>> i.e. <<High Velocity Oxy-Fuel>> or <<HVAF>> i.e. <<High Velocity Air Fuel>>, and plasma spraying (blown arc or radio frequency plasma).

A description of these methods is made in document [1] and in document [2].

All kinds of substrates may thus be provided with a coating and acquire a reinforced function during their use.

For example, these substrates may be provided with a coating acting as a heat barrier, or an anti-corrosion barrier, an anti-wear layer etc., or further as a layer imparting them heat stability, hardness properties, etc.

But many problems subsist notably related to incompatibility between certain thermal projection techniques and the characteristics of the part to be coated, or else between the fed material intended to form the coating and the part to be coated.

Thus, some thermal projection methods do not allow coating of mechanically brittle parts, the heat sensitivity of which is significant, or of parts with a complex shape having inaccessible areas.

With the fed material, problems of wettability, adhesion and differential expansion with the material which forms the part to be coated are posed.

One of the fundamental properties which the coatings made by thermal projection, spraying should have is adhesion of the coatings to the surface of the part to be coated further called a subjectile.

Different adhesion mechanisms have been shown, these mechanisms are the following:
mechanical anchoring: it is generally due to contraction of the projected, sprayed material into the irregularities, unevennesses of the subjectile;
adsorption: this is adhesion which may generally be described as “chemical” adhesion which may range from chemisorption due to Van der Waals forces to physisorption due to permanent dipoles.
electrostatic adhesion: it may be caused by a double layer of charges of opposite sign at the interface.
diffusion: this may be molecular diffusion in the case of polymers, or atomic diffusion in the case of alloys, in the vicinity of the interface.

Several studies have shown that the preponderant mechanism in thermal projection is the mechanical anchoring of the projected particles on the irregularities, unevennesses present at the surface of the subjectile.

In order to obtain increased mechanical adhesion, different surface preparation methods are used, the most common being shot-blasting with various abrasive materials such as sand, corundum and ice as this is described in documents [5] and [6].

However, upon the impact of the abrasive material on the surface, residues remain anchored in the surface and are sources of pollution. This is why the technique of ablation by a high pressure water jet has been developed. This technique, which allows modification of the roughness of the surface of the substrate, the subjectile, without incorporating therein abrasive residues, is notably described in documents [7] and [8].

However, in addition to possible surface contamination phenomenon, the surface preparation techniques mentioned above require the use of high pressures and therefore induce, depending on the cases, compression or traction stresses which may reach 400 MPa on the surface of the subjectile. These stresses may in the case of substrates with small thicknesses, generate non-negligible deformations.

In order not to deform the substrate by mechanical stresses, other surface preparation techniques have been developed.

Thus, documents [10] and [11] propose the use of laser irradiation which may cause total or partial removal of the surface-contaminating film and modification of the morphology of the surface of the subjectile.

Document [12] mentions the use of electric discharges between an electrode and the substrate in order to suppress the oxide layers and to generate roughness.

Different studies, discussed in documents [13], [14], and [15] show the influence of adhesion mechanisms other than mechanical anchoring, which are relatively complex and uncontrolled.

It appears that the use of the techniques mentioned above, said to be surface activation techniques, may be difficult to contemplate industrially for preparing a surface prior to thermal spraying because of their relatively high financial cost.

As a summary, industrial or experimental techniques for activating or preparing a surface as described above, which have the goal of improving adhesion of coatings prepared by thermal projection, spraying either have the drawback of high financial cost or the drawback of generating mechanical stresses in the substrate to be coated.

Therefore there exists a need for a method for preparing a microstructured coating on a substrate by means of a thermal projection, spraying, method via a dry, conventional route, with which a coating may be obtained having excellent improved adhesion properties, without resorting to the preparation or activation of the surface of the substrate other than simple cleaning.

In the early 1990's, a novel thermal projection, spraying technique appeared, i.e. the spraying of nanomaterials via a <<liquid route>>, a so-called suspension projection.

The carrier gas and the micrometric particles of conventional thermal spraying are replaced with a suspension, dispersion or mixture of a liquid and of nanometric particles.

Indeed, in the conventional thermal spraying method, via a dry route, the particles have to have sufficient momentum for promoting their penetration of the spraying gas and thereby allowing an adequate heat treatment of these particles.

However, nanometric particles because of their low mass, cannot reach sufficient momenta, unless the flow rate of carrier gas is increased very significantly, which has the consequence of significant deviations of the spraying gas, making any building of the deposit impossible.

By using a suspension, the use of nanometric particles which was not possible with the <<conventional>> method via dry route, becomes possible.

Indeed, in contact with the spraying gas, the jet of suspended particles will break up and the liquid will evaporate, the particles will therefore be able to be heat-treated and accelerated towards the part to be coated, in order to thereby form a finely structured coating, as this is described in document [16].

Document [17] describes a system with which deposits may be made by plasma spraying from suspended nanoparticles.

Thermal projection of suspensions is also the subject of documents [18], [19], and [20].

Complementary studies have determined the parameters of the method which influence the building of the deposit ([21], [22]) and the possible cohesion with the substrate ([23], [24], and [25]).

The nanostructured layers have optimized properties, both mechanical and physico-chemical properties. Indeed, a decrease in the size of the particles allows a strong increase in their specific surface area, in the number of interparticulate contacts as well as the shape, size and geometry of the porosities.

Because of the decrease in the size of the particles used in the method for thermal spraying of a suspension, new phenomena should be taken into a account.

Thus, mechanical adhesion requires surface irregularities, unevennesses with a significantly smaller size, i.e. submicron or even nanometric sizes, and new adhesion mechanisms appear such as Van der Waals forces or electrostatic forces.

The coatings prepared by thermal spraying of suspensions therefore do not require any particular preliminary surface preparation.

Document [26] shows that it is possible to produce deposits with optimized properties and with a non-negligible thickness (100 μm). However, a too large increase in the thickness of the nanostructured deposit may cause its decoherence [27].

Thermal spraying of suspensions is therefore limited to the making of so-called <<thin>> layers, i.e. with a thickness of generally less than 150 μm.

Thermal spraying methods via a liquid route therefore allow the preparation of adhering layers, but these are only nanostructured or finely structured layers and not-microstructured layers which are not very thick.

The need, already mentioned above for a method for preparing a microstructured coating on a substrate by a thermal spraying method with which a coating may be obtained, having improved excellent adhesion properties, without having to resort to preparation or activation of the surface of the substrate other than to simple cleaning, therefore remains unsatisfied.

In other words, therefore, considering the foregoing, a need exists for a method for preparing a coating on a substrate by thermal spraying which does not have the drawbacks, defects, limitations and disadvantages of the method of the prior art such as the conventional methods via a dry route and which solve the problems of these methods.

The goal of the present invention is to provide such a method which inter alia meets this need.

### SUMMARY OF THE INVENTION

This goal and still other ones are achieved according to the invention by a method for preparing a multilayer coating on a surface of a substrate by means of at least one thermal spraying method, in which the following successive steps are carried out:

a) a first nanostructured or finely structured layer of a first material is deposited on the surface of the substrate by a thermal spraying method via a liquid route; the surface of the substrate not having been subject, prior to the deposition of the first nanostructured or finely structured layer, to any preparation or activation treatment other than an optional cleaning treatment;

b) a second microstructured layer of a second material is deposited on the first nanostructured or finely structured layer by a thermal spraying method.

By cleaning, is also meant degreasing.

Advantageously, the coating is a thick coating.

By thick coating, in the sense of the invention, is generally meant that the coating has a thickness greater than or equal to 100 μm, preferably greater than or equal to 150 μm.

The thickness of the coating, which is generally greater than or equal to 100 μm, preferably greater than or equal to 150 μm, may generally range up to 1 mm or even 10 mm, and this thickness is equivalent to that of a deposit obtained by a conventional spraying method in which a preparation, activation of the surface is carried out for example by mechanical sanding.

In other words, in the method according to the invention, a deposition of a <<thick>> coating is generally made with a thickness which may be described as conventional, except that no preparation of the surface of the substrate is carried out for increasing the roughness thereof, and that in order to retain good adhesion, one begins by depositing a nanostructured or finely structured first layer via a liquid route.

The thermal spraying method carried out in step b) may be any method.

However, advantageously, the thermal spraying method of step b) may be a thermal spraying method via a dry route.

Advantageously, during step a), the thermal spraying method may use a suspension of nanometric or submicron particles of the first material.

By nanometric particles is generally meant that these particles have a size, as generally defined by their largest dimension, from 1 to 100 nm.

By submicron particles is meant generally that these particles have a size generally defined by their largest dimension, from more than 100 nm to 1,000 nm.

These nanometric or submicron particles, for which the size is therefore located generally within the range of one hundred nanometers cannot be projected, sprayed by a conventional method via dry route, but only by a method via a liquid route.

These nanometric or submicron particles are then treated, whereby the nanometric or submicron particles form the first nanostructured or finely structured layer of the first material on the surface of the substrate.

Or else, during step a), the thermal spraying method uses a solution of reagents which are precursors of the first material.

This solution of precursor reagents is then treated with an enthalpy source, whereby the precursor reagents react and form the first nanostructured or finely structured layer of the first material on the surface of the substrate.

Advantageously, the thickness of the first nanostructured or finely structured layer of the first material deposited on the surface of the substrate, may be greater than the thickness of said first layer in the final multilayer coating obtained at the end of the method.

Advantageously, during step b), the thermal spraying method uses a dry powder of micron-size, micrometric particles of the second material, and these micron-size particles are then treated, whereby the micron-size particles form the second microstructured layer of the second material on the first layer.

Advantageously, the second material has the same composition as the first material (in other words the first material and the second material are the same) and/or the second material has a crystallographic structure close to the one of the first material, and/or the second material has a thermomechanical behavior close to that of the first material.

In other words, advantageously, the nanostructured layer has the same (chemical) composition as the microstructured layer.

Expressed otherwise, advantageously, the nanostructured layer and the microstructured layer are in a same material and differ by the fact that one has a nanostructure while the other one has a microstructure.

Advantageously, after step b), a step c) is carried out during which a third microstructured or nanostructured or finely structured layer of a third material is deposited on the second microstructured layer of the second material by a thermal spraying method.

The thermal spraying method for depositing the third layer may be a thermal spraying method via a dry route or via a liquid route.

The third layer may actually be microstructured or nanostructured or finely structured depending on the sought application. Thus, a third nanostructured or finely structured layer is preferred for example in the case when it is desired to provide imperviousness to the coating.

The second and third layers of steps b) and c) may have different functions.

Advantageously, the third material has the same composition as the second material (in other words, the third material and the second material are the same) and/or the third material has a crystallographic structure close to that of the second material, and/or the third material has a thermomechanical behavior close to that of the second material.

In other words, advantageously, the third layer has the same (chemical) composition as the second layer.

Expressed otherwise, advantageously, the third layer and the second layer are in a same material.

Advantageously, the thermal spraying method via a liquid route used in step a) is selected from supersonic or hypersonic spraying methods designated as <<HVOF>> i.e. <<High Velocity Oxy-Fuel>> or <<HVAF>> i.e. <<High Velocity Air Fuel<<, the detonation gun spraying method called <<D-GUN>> method, and the plasma spraying methods, for example with a blown arc or radiofrequency plasma.

Advantageously, the thermal spraying method used in step b) is a thermal spraying method via a dry route selected from methods used for step a), i.e. supersonic or hypersonic spraying methods designated as <<HVOF>> i.e. <<High Velocity Oxy-Fuel>> or <<HVAF>> i.e. <<High Velocity Air Fuel>> methods, the detonation gun spraying method called <<D-GUN>> method, and the plasma spraying method for example with a blown arc or radiofrequency plasma; and further from the flame-powder spraying method and the arc-wire spraying method.

Advantageously, the thermal spraying method used in step c) is either a thermal spraying method via a liquid route selected from thermal spraying methods via a liquid route used for step a), i.e. supersonic or hypersonic spraying methods designated as <<HVOF<< i.e. <<High Velocity Oxy-Fuel>> or <<HVAF>> i.e. <<High Velocity Air Fuel>>, the detonation gun spraying method called <<D-GUN>> method, and the plasma spraying methods, for example with a blown arc or radiofrequency plasma, in the case when the layer deposited during step c) is a nanostructured or finely structured layer; or else a thermal spraying method via a dry route selected from spraying methods via a dry route used for step b), i.e. supersonic or hypersonic spraying methods designated as <<HVOF>> i.e. <<High Velocity Oxy-Fuel>> or <<HVAF>> i.e. <<High Velocity Air Fuel>>, the detonation gun spraying method called <<D-GUN>> method, and the plasma spraying method, for example with a blown arc or radiofrequency plasma, and, further from the flame-powder spraying method and the arc-wire spraying method in the case when the layer deposited during step c) is a microstructured layer.

Advantageously, prior to step a), the substrate is preheated and/or prior to step b) the first layer is preheated.

Advantageously the first, second and third materials are selected independently of each other from ceramics, preferably oxide ceramics, metals and cermets.

Advantageously the first and second materials, and optionally the third material are a same ceramic, preferably an oxide ceramic such as yttria stabilized zirconia, YSZ.

Advantageously, the substrate is made of a material selected from metals and metal alloys.

These metal alloys may notably be selected from steels, preferably from stainless steels.

Advantageously, the first and the second material, and optionally the third material, are a same ceramic, preferably a same oxide ceramic, such as yttria stabilized zirconia (YSZ), and the substrate is a substrate made of metal or made of metal alloy, preferably a substrate made of steel, for example a substrate made of stainless steel.

The method according to the invention has a specific sequence of specific steps which has never been described or suggested in the prior art, notably illustrated by the documents mentioned above.

The method according to the invention may be defined as a method in which a first nanostructured or finely structured layer is prepared by thermal spraying, generally by thermal spraying via a liquid route, and this nanostructu red or finely structured layer is used as an adhesion layer for a microstructured layer also prepared by thermal spraying, generally by a conventional thermal spraying, via a dry route. A coating is finally obtained, globally prepared by thermal spraying and having excellent adhesion on the substrate.

Surprisingly, excellent adhesion of the microstructured layer on the substrate not prepared beforehand is obtained in this way by means of the method according to the invention even though up to then, for obtaining such adhesion, it was necessary to resort to mechanical anchoring of this microstructured layer on the substrate.

Notably, it is generally no longer necessary with the method according to the invention, to carry out preliminary preparation of the surface of the substrate, such as with sanding, in order to increase the surface roughness in order to promote mechanical anchoring of a coating and in particular of a thick coating.

More generally, it is not necessary with the method according to the invention, to carry out a prior preparation or activation of the surface of the substrate whichever it may be. In other words, in the method according to the invention, there is no modification of the surface condition of the part, substrate to be coated, prior to the deposition of the first layer.

The method according to the invention allows preparation of coatings, and notably of thick coatings, having excellent adhesion on substrates by thermal spraying, without resorting to surface preparation or activation, other than a simple cleaning of the surface of the substrate.

By achieving excellent adhesion of a microstructured layer and of a coating, in particular of a thick coating, prepared by thermal spraying on a substrate, although, surprisingly, a treatment for preparing or activating the substrate is not carried out beforehand, the method according to the invention goes against the prejudice according to which preparation or activation of the surface of the substrate was required in order to obtain adhesion of such microstructured layers and of such coatings, in particular such thick coatings, on a substrate.

The coatings prepared by the method according to the invention, the adhesion of which is improved as compared with the microstructured coatings prepared on substrates having been subject to surface activation or preparation do not further have any of the drawbacks in connection with these treatments for preparing and activating the surface of the substrate, notably in terms of financial costs and of mechanical stresses.

To summarize, the method according to the invention for the first time allows preparation of a thick and adherent coating on a surface of a substrate by a thermal spraying method without preparing or activating in any way this surface except by simple cleaning. The method according to the invention therefore gets rid of all the adhesion problems related to the nature and/or to the roughness of the surfaces to be coated, it is of a very general application and ensures excellent adhesion of the coating regardless of the nature of the surface of the substrate, the condition of this surface notably defined by the roughness, the shape, geometry, even complex, of said surface, and the size of this surface.

The method according to the invention does not have the drawbacks of the methods of the prior art and overcomes the problems of the methods of the prior art. Indeed, it does not have the drawbacks of the methods for preparing coatings by means of conventional methods via a dry route in the sense that it ensures excellent adhesion of the essentially microstructured coatings on the substrate without any prior activation or preparation.

As compared with preparation methods via liquid route by spraying of a suspension, the method according to the invention allows preparation of thick and coherent coatings which was not possible with this type of method.

In other words, the method according to the invention inter alia consists of:
generating a coating, in particular a ceramic coating with a thickness adapted to industrial needs, which is strongly adherent on a part, in particular a metal part;
generating a coating, in particular a ceramic coating without any prior surface preparation;
using a nanostructured or finely structured layer which is strongly adherent as a sublayer of a deposit, preferably a microstructured <<conventional>> deposit, in order to thereby generate adhesion via a multilayer system.

The method according to the invention inter alia gives the possibility:
of controlling the thickness of the final coating which may range from a few hundred nanometers to a few millimeters, for example from 1 mm to 5 mm.
of being able to produce coatings on parts with complex shapes and diverse sizes.

The method according to the invention may be rapidly industrialized and with a lesser production cost than the methods of the prior art.

It may be noted that nanostructured or finely structured layers prepared by thermal spraying, have never been used as prior surface preparation and anchoring layers to a microstructured <<conventional>> layer also prepared by thermal spraying.

According to the invention, it has been shown that these nanostructured layers which allow, via a multilayer system, optimization of the adhesion of a more or less thick coating on a surface having not been prepared beforehand and therefore simplification of the spraying procedures.

The use of bilayer or even multilayer systems for optimizing the adhesion, with prior surface preparation, has no doubt already been the subject of various studies, notably in aeronautics and aerospace as indicated in document [28].

But this use is limited to systems using microstructured metal sublayers, for example of the NiCrAlY type. Further, these microstructured layers are produced, with initial sanding, by spraying methods which are not spraying methods via a liquid route requiring the spraying of suspensions or solutions.

Indeed, the problems of adhesion of a ceramic on a metal are not new problems and are for a large part due to stresses caused by the differences in thermal expansion coefficients between the substrate and the coating.

For this, the use of a multilayer system, with a metal sublayer of the NiCrAlY type, allows a thermal expansion coefficient gradient to be generated between the substrate and the last functional layer of the coating, and thus the mechanical stresses [32], [33] [34], [35], [36], [37] may thereby be limited. Nevertheless, the adhesion is always of a mechanical origin and the substrates always require a preparation in order to have the high roughness required for adhesion of microstructured layers of large thickness [38], [39], [40], [41], [42].

It is also possible to find various coating techniques using nanostructured multilayer systems for promoting adhesion [43], [44], [45]. But all these techniques, such as physical vapor deposition (PVD), electron beam physical vapor deposition (EB-PVD), chemical vapor deposition (CVD), and plasma-enhanced chemical vapor deposition (PECVD), are complex and require surface preparation, for example a polished surface, a high vacuum (about 10⁻⁵ mbars) [46] and are only applicable for thin layers. It is therefore indispensable to have a specific piece of equipment and a specific environment, which leads to limitation of the size and shape of the parts to be coated and considerably increases production costs.

It should be noted that heretofore, the superposition of a nanostructured layer and of a microstructured layer, the nanostructured layer playing the role of an anchoring layer for a microstructured layer, has never been achieved in order to improve the adhesion while preferably keeping the same chemical composition of both layers.

The invention will be better understood upon reading the detailed description which follows, especially made in connection with preferred embodiments of the method of the invention, this description being given as an illustration and not as a limitation.

### BRIEF DESCRIPTION OF THE DRAWINGS

The detailed description is made with reference to the appended drawings, wherein:

FIG. 1 is a schematic view which shows a thermal spraying device for carrying out the method according to the invention;

FIG. 2 is a schematic cross-sectional view of a bilayer coating, system, prepared by the method according to the invention, on a substrate, subjectile;

FIG. 3 is a schematic vertical sectional view of a trilayer coating, system, prepared by the method according to the invention, on a substrate, subjectile;

FIG. 4 is an image obtained by scanning electron microscopy which shows the microstructure obtained in the example by the method according to the invention.

### DETAILED DISCUSSION OF PARTICULAR EMBODIMENTS

The method according to the invention may be described as a method for preparing a multimodal, multilayer system, coating, by thermal spraying onto a surface of a substrate, also called a subjectile, to be coated. The thermal spraying may be achieved under a normal, controlled, for example inert or neutral, or low pressure atmosphere, i.e. under a pressure of a few millibars.

By multimodal system is meant that the coating, system, comprises at least two layers which are different by their structure, their structural scale and their organization. Thus the first layer is a nanostructured or finely structured layer, while the second layer is a nnicrostructured layer.

By nanostructured or finely structured layer, is generally meant that this layer has an organization on a nanometric scale, i.e. on a scale ranging from one or a few nanometers up to one hundred to a few hundred nanometers. Also, by microstructured layer is meant that this layer has an organization on a micrometric scale, i.e. on a scale ranging from one or a few micrometers up to one hundred to a few hundred micrometers.

Each of the layers of the method according to the invention may be deposited by means of a different thermal spraying method and by means of a different thermal spraying device, but it is advantageous to achieve deposition of all the layers and notably of the first and second layers with the same method and the same thermal spraying device.

This device should preferably be easily adapted so as to either achieve spraying of micrometric powders of materials, such as ceramics, via the conventional route or dry route, or projection of suspensions of micron-size powders of materials such as ceramics, via the liquid route, or further the projection of solutions of reagents which are able to form after treatment with an enthalpy source, a nanostructured or finely structured deposit.

The thermal spraying method applied by the device may be of any nature and may notably be selected from the thermal spraying methods already mentioned above, i.e. flame-powder spraying, arc-wire spraying, supersonic or hypersonic spraying designated as <<HVOF>> i.e. <<High Velocity Oxy-Fuel>> or <<HVAF>> i.e. <<High Velocity Air Fuel>>, and plasma spraying according to their adaptability to the dry route and to the liquid route.

Among these methods, the man skilled in the art will easily identify those which may be applied via a dry route and those which may be applied via a liquid route.

The selection of the thermal spraying method depends on the melting temperatures of the material to be projected, sprayed, and of the material making up the subjectile, the substrate to be coated. Advantageously, this device may be placed on a robot arm in order to sweep over the entirety of the surface of the substrate, of the part to be coated, in order to thereby uniformize the multilayer coating.

The size, the shape and the geometry of the substrate, of the part, of the subjectile to be coated by the method according to the invention, may be of any kind. Indeed this is one of the advantages of the method according to the invention, to allow the preparation of a coating which adheres on any kinds of part regardless of their shape, size and geometry, even complex. In fact, the only restriction which the application of the invention may encounter, lies in the mechanical positioning capabilities of the robot and is not due to the characteristics of the method as such.

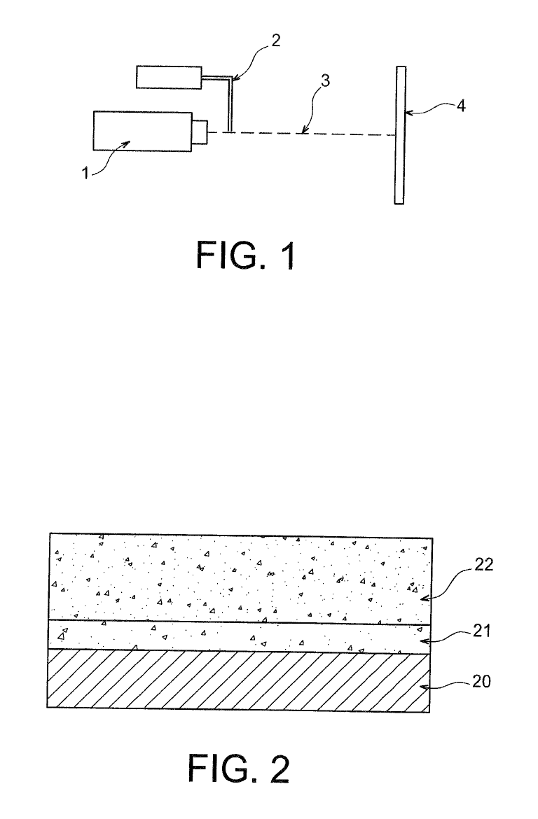

A device for applying, carrying out, the method according to the invention is illustrated in FIG. 1; for the purpose of simplification, the robot arm with which the device is generally provided, has been omitted in FIG. 1.

This thermal spraying device first of all comprises a device allowing injection and acceleration of the particles (1) which also plays the role of an enthalpy source.

The device (1) varies according to the applied thermal spraying method. In this respect, reference may be made to documents [1], [2] or [17].

The thermal spraying device then comprises a system (2) for supplying the coating materials which may be found either in the form of dry powders in the case when the conventional route or dry route is used, or in the form of suspensions of these powders or in the form of solutions of precursor reagents in the case when the liquid route is used.

In FIG. 1, the path (3) of the molten, semi-molten, or solid particles in flight which are being deposited on the subjectile to be coated (4), is also illustrated.

The subjectile (4) may be made of a material selected from metals and metal alloys such as for example steel, nickel-based alloys, such as alloys available under the name of Haynes®, inconels . . . .

Prior to the deposition of the first layer of a first material on the surface of the substrate, subjectile, to be coated, this surface is generally cleaned, for example degreased with a solvent, this is a conventional industrial process.

In accordance with the method according to the invention, the surface of the substrate does not undergo any activation or preparation treatment other than this optional cleaning, for example degreasing treatment. This cleaning treatment by no means affects the structure or the composition of the surface of the substrate, in other words the surface condition of the substrate, and has the purpose of removing impurities, pollutants and other foreign bodies at the surface of the substrate which are distinct from the latter and do not belong to it.

The surface of the substrate may possibly be described as a <<smooth>> and <<clean>> surface.

This surface does not provide the possibility of mechanical anchoring on the scale of a microstructured layer.

The substrate, subjectile, may optionally be preheated, prior to the deposition by any adequate means, to a temperature for example from 25 to 600° C.

The preheating temperature depends on the properties of the coating materials and of the substrates.

This preheating step allows improved adhesion between the subjectile (4) and the first layer of the coating.

Subsequently to this optional preheating step, the surface of the substrate, subjectile, is coated with a first nanostructured or finely structured layer of a first material by means of a thermal spraying method via a liquid route.

The method via a liquid route which is applied for depositing the first layer of the coating may use nanometric particles (nanoparticles), or even submicron particles of the first material, in suspension, which are then treated in a known way, depending on the selected spraying method, and form the first nanostructured or finely structured layer (21) at the surface of the subjectile (20), as this is shown in FIG. 2.

Any spraying method capable of projecting, spraying, suspended nanometric powders may be used for depositing the first layer or adhesion layer.

The Prosol® method which is notably described in patent application [17], to the description of which reference may be made, is a method which may be suitable for depositing the first nanostructured or finely structured layer.

The nanoparticles or nanometric particles generally have a size from 1 to 500 nm, preferably from 1 to 100 nm, still preferably from 1 to 50 nm.

The submicron particles generally have a size from 200 nm to 1 μm, preferably from 200 to 800 nm. Or else, the method which is applied for depositing the first layer, uses a solution of reagents which are precursors of the first material, which is treated in a known way with an enthalpy source, specific to the method, and may react and form a deposit (21) also nanostructured at the surface of the subjectile (20) with the same composition as the first material deposited by spraying of a suspension.

The spraying parameters will be adapted to the first material to be projected, sprayed.

The first material which constitutes the first layer (21) of the coating prepared by the method according to the invention is generally selected from ceramics, preferably from metal oxide(s), such as zirconia, alumina, silica, hafnium oxide (hafnia), titanium dioxide, etc.

In the case when a solution of reagents which are precursors of the first material is used, the reagents are generally selected from metal salts and metal alkoxides.

During the preparation of the first layer (21) or binding layer, the spraying atmosphere or more specifically the atmosphere in which the spraying is achieved, is not necessarily an oxidizing atmosphere since the oxidation of the particles in flight is unnecessary.

The first nanostructured or finely structured layer (21) of the first material, is strongly adherent and is used as a binding layer and anchoring layer to the upper layers and firstly to the second layer consisting in a second material.

This first layer may thus be designated as <<nanostructured binding layer>> (21).

This first layer has nanostructuration i.e. it is structured on a nanometric scale. Thus, if spherical particles are for example projected, sprayed, for example having a diameter of 500 nm, these particles upon their impact on the subjectile will be crushed, flattened so as to give lamellas with a thickness from 20 to 30 nm. A layer will therefore be obtained, consisting in a stack of these fine lamellas which overlap in order to form a finely structured deposit with nanoporosity or porosity on a nanometric scale.

The thickness of this first layer (21) depends on the material to be projected, sprayed. This thickness may generally range from one to a few μm up to less than 150 μm (in terms of deposited thickness).

In other words, the thickness of the first layer may range up to 150 μm, the value of 150 μm being excluded.

Indeed, it is preferable that the thickness of the first layer (21) which is a nanostructured or finely structured layer, be less than 150 μm, since for larger thicknesses the coherence of this layer is not ensured.

Preferably, the deposited thickness of the first layer (21) is from 1 μm to 100 μm.

Advantageously, this first layer (21) may have a thickness greater than its rated, nominal, functional thickness (i.e. its thickness in the final multilayer coating obtained at the end of the deposition of all the layers), because an ablation phenomenon may occur with the production of the second layer.

Thus, if it is desired that the rated, nominal, functional thickness of the first layer be from 1 to 100 μm, the thickness of the initially deposited layer before depositing the second layer may be from 1 to 150 μm.

Subsequently to the deposition onto the surface of the substrate of the first layer (21) of the first material, deposition of a second microstructured layer (22) of a second material is carried out by means of a thermal spraying method on this first layer.

No preparation, activation of the first layer is required before proceeding with the deposition of the second layer.

The first layer (21) may optionally be preheated, prior to the deposition of the second layer (22), to a temperature for example from 25 to 600° C. by any adequate means.

This preheating step allows improved adhesion between the first layer and the second layer of the coating, notably when these are two ceramic layers.

Any thermal spraying method allowing preparation of a microstructured layer may be used.

This second microstructured layer is generally deposited by means of a <<conventional>> thermal spraying method via a dry route.

The spraying method which is applied for depositing the second layer of the coating uses a dry powder of micrometric particles of the second material, which are projected, sprayed onto the surface of the subjectile, and form in a known way the second microstructured layer (22) at the surface of the first nanostructured or finely structured layer (21).

The micrometric particles or micro particles generally have a size from 5 to 150 μm, preferably from 10 to 20 μm, or else from 20 to 60 μm depending on the type of method used.

The second material which constitutes the second microstructured layer (22) generally has the same composition as the first material, or the second material has a crystallographic structure close to that of the first material, or the second material has a thermal mechanical behavior close to that of the first material. By thereby selecting the first material of the nanometric or finely structured layer (21) and the second material of the micrometric layer (22), a maximum of cohesion between both layers is ensured.

In other words, according to the invention, the same material is preferably used for the binding layer (21) and for the upper layer (22).

The materials of these layers are therefore preferably identical.

This homogeneity in the composition of the different layers is one of the additional advantages provided by the method according to the invention in this preferred embodiment.

Advantageously, because of the homogeneity of composition of the layers, control of the cohesion of the layers does not require control of the oxidation notably at the surface of the binding layer (21).

In other words, no oxidation problem exists at the interface between the layers when, advantageously, both layers are of identical composition.

When the material of the first layer advantageously has the same composition as the material of the second layer, no composition gradient exists in the coating.

The second material which constitutes the second layer of the coating prepared by the method according to the invention is, in the same way as the first material, generally selected from ceramics, preferably from metal oxide(s), such as zirconia, alumina, silica, hafnium oxide (hafnia), titanium dioxide, etc., these particles may be dense or porous.

The spraying parameters of the thermal spraying method applied for depositing the second layer will also be adapted to the second material (22).

The thickness of the second layer generally depends on the function of this layer.

The thickness of the second layer may range from 10 μm to 5 mm, preferably from 10 to 1,000 μm.

Thus according to the invention, thick microstructured layers may be prepared on a substrate while obtaining excellent adhesion on the latter and without carrying out any activation or preparation treatment of the substrate, or of the first layer.

The adhesion between the first and the second layers (21, 22) is accomplished chemically and is the result of the thermokinetic state of the particles of the second layer (22) which is related to the spraying parameters. This adhesion is accomplished by penetration of the particles of the second material into the layer (21) and therefore by mechanical anchoring.

It should further be noted that no post-treatment, i.e. no treatment after the deposition, is generally required between the layers and on the final coating.

In other words, post-treatment is generally neither carried out on the first layer at the end of its deposition, nor on the second layer at the end of its deposition.

In order to better control the structural and therefore physico-chemical properties of the multilayer system, it is possible to deposit an additional layer or third layer (23), as this is shown in FIG. 3. This third layer may be called a layer for adjusting the properties of the multilayer.

This layer may be nanostructured or finely structured or microstructured, the two lower layers being used as a adhesion layer for this third layer.

The third material which makes up this layer (23) may be identical in composition with the second material or of a crystallographic structure close to that of the second material, or with a thermomechanical behavior close to the one of the second material, notably according to industrial needs. By thereby selecting the second material of the micrometric layer (22) and the third material of the layer (23), maximum cohesion between both layers (22) and (23) is ensured.

In other words, advantageously, the third layer has the same (chemical) composition as the second layer.

Expressed otherwise, advantageously, the second layer and the third layer are made of a same material.

The advantages provided by the selection of a third material having a composition identical with that of the second material are similar to those obtained by selecting a second material having a composition identical with that of the first material and they have already been discussed above. Notably, when the third material is identical with the second material, there are no oxidation problems between the second and the third layers.

Advantageously, the first material, the second material and the third material all three are of identical composition, have the same (chemical) composition.

Expressed otherwise, advantageously, the three layers are made of a same material, for example made of a same ceramic.

When the material of the three layers advantageously has the same composition, no composition gradient exists in the coating.

The third material which constitutes the third layer (23) of the coating prepared by the method according to the invention is, like the first material and the second material, generally selected from ceramics, preferably from metal oxide(s), such as zirconia, alumina, silica, hafnium oxide (hafnia), titanium dioxide etc., these particles may be dense or porous.

This third layer (23), when this is a microstructured layer is generally deposited by a <<conventional>> thermal spraying method via a dry route in a similar way to the second layer (22).

This third layer (23), when this is a nanostructured or finely structured layer, is generally deposited by a thermal spraying method via a liquid route in a similar way to the first layer (21).

The spraying parameters of the thermal spraying method applied for depositing the second layer will also be adapted to the third material (23).

The thickness of the third layer generally depends on the function of this layer.

The thickness of the third layer may range from 10 μm to 5 mm, preferably from 10 μm to 1 mm in the case of a microstructured layer, and from 1 μm to 100 μm, preferably 10 μm to 60 μm, in the case of a nanostructured or finely structured layer.

The second layer (22) and the third layer (23) of the coating generally have properties of different functions.

Thus, the second layer (22) may be defined as a functional layer which will give an improved function to the coated, part, substrate. For example, this second layer (22) may be a thermal barrier or electric barrier layer.

The third layer (23) which, as this has been seen, may be defined as a layer for adjusting the properties of the multilayer coating, is the external layer which imparts to the coating, essential properties towards the environment.

For example, the third layer may give properties of tightness to exterior gases, anti-corrosion properties (for example towards acids), anti-wear properties, heat-barrier properties. In particular, if the third layer is a nanostructured or finely structured layer, it will have less porosity and will therefore be more tight notably towards gases.

It should be again noted that no post-treatment is generally required between the three layers and on the final coating.

In other words, a post-treatment is generally neither carried out on the second layer, at the end of its deposition, nor on the third layer, at the end of its deposition.

The method according to the invention allows preparation of coatings which have variable thicknesses, but it proves to be particularly advantageous for preparing thick coatings, i.e. generally with a thickness greater than or equal to 100 μm, preferably with a thickness greater than or equal to 150 μm, which, by means of the method according to the invention, have excellent adhesion and excellent cohesion.

The final coating which is essentially a micrometric microstructured coating, thus has a thickness generally from 100 μm to 10 mm, preferably from 150 μm to 10 mm, still preferably from 150 μm to 1 mm.

Such a coating notably finds its application in the aeronautical, space, ship-building and nuclear industries.

It was shown above that the invention exploits the use of a first nanostructured or finely structured layer made by thermal spraying as an adhesion layer for coatings, preferably thick coatings conventionally made by thermal spraying and usually requiring mechanical adhesion. It is no longer necessary to carry out any preliminary preparation in order to increase the surface roughness for promoting mechanical anchoring of a thick coating.

The method according to the invention is not limited to the preparation of heat-barriers but may be suitable for preparing any coating.

The invention will now be described with reference to the following example, given as an illustration and not as a limitation.

### Example

This example illustrates the making of a bilayer system on a AISI 304L substrate of 50×50 mm², as machined (Rₐ^{˜}0.5 μm):

Step 1: Cleaning the Sample
Acetone bath (30 minutes).
Ethanol bath activated with ultrasonic waves.

Step 2: Making the Layer C₁(21)

A nanostructured coating of YSZ (yttria stabilized zirconia) produced by plasma projection, spraying via a liquid route:
Size of the suspended particles: 30-60 nm.
Loading rate of the suspension: 6% by mass.
Suspension flow rate: 70 g/min.
Type of plasma torch: Sulzer-Metco®, type F4.
Relative torch/substrate velocity: 1.5 m/s.
Projection, spraying distance: 40 mm.
Plasmaforming mixture and flow rate of the gases used: Ar/He/H₂, 45/45/3 NL/min
Power output of the torch: ^{˜}28 kW.
Temperature for preheating the substrate: 250° C.
Projection, spraying time: 15 min.

Step 3: Making the Layer C₂(22)

Microstructured coating of YSZ (yttria stabilized zirconia) made by conventional plasma projection, spraying (dry route):
Size of the particles: 22-45 μm.
Chemical composition of the powder: same as layer C₁(21).
Powder flow rate: 20 g/min.
Projection, spraying distance: 150 mm.
Plasmaforming mixture: Ar/He/H₂.
Temperature for preheating the layer C₁: 250° C.
Projection, spraying time: 10 min.

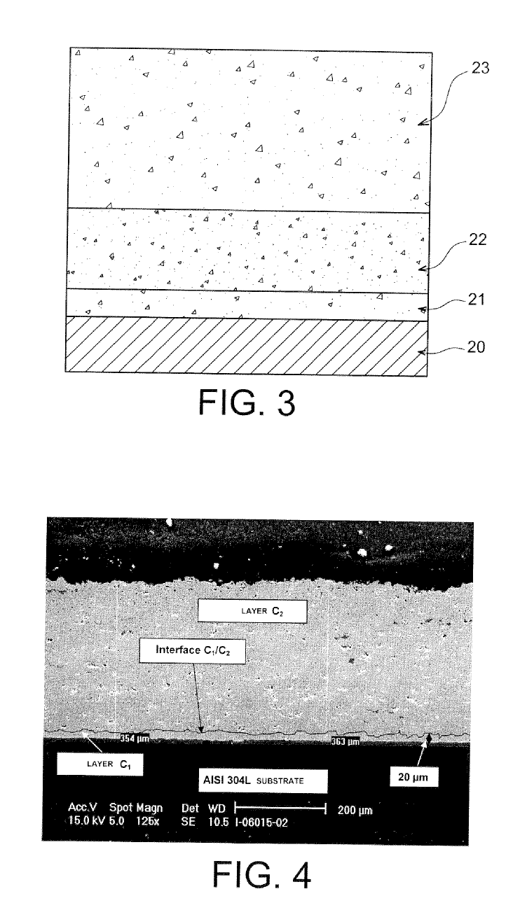

The thickness of the first layer C₁ (21) is of about 20 μm, and the total thickness of the coating is from about 350 to 360 μm, for example 354 μm or 363 μm as shown in FIG. 4.

Observation of the Obtained Microstructure:

FIG. 4 is an image obtained by a scanning electron microscope which shows the different deposited layers as described above on the substrate.

It can be seen on the photograph of FIG. 4 that the interface between the first layer C₁ (21) and the second layer C₂ (22) is hardly visible, which shows that the coherence between these two layers is excellent.

### REFERENCES

[1] A. Proner, Revêtements par projection thermique, Techniques de I'ingénieur, 1999, M 1645, pp 1-20.
[2] L. Pawlowski, The science and Engineering of Thermal Spray Coatings, John Wiley & Sons, New York, 1995.
[3] M. G. Nicholas and K. T. Scutt, Characterization of grit blasted surface, Surfacing J., 12 (1981) 5.
[4] M. Mellali, A. Grimaud et P. Fauchais, Parameters controlling the sand blasting of substrates for plasma spraying, Proc. 7^{th} Thermal Spray Conf., 20-24 Jun. 1994, Boston, ASM International, Orlando Fla., 1994.
[5] J. Wigren, Technical note: Grit blasting as surface preparation before plasma spraying, Surface and Coatings Technology, 34 (1988) 101-108.
[6] F. Elbing, N. Anagreh, L. Dorn, E. Uhlmann, Dry ice blasting as pretreatment of aluminium surfaces to improve the adhesive strength of aluminium bonding joint, International Journal of Adhesion & Adhesives, 23 (2003) 69-79.
[7] T. A. Taylor, Surface roughening of metallic substrates by high pressure pure waterjet, Surface and Coatings Technology, 76-77 (1995)95-100.
[8] J. K. Knapp, T. A. Taylor, Waterjet roughened surface analysis and bond strength, Surface and Coatings Technology, 86-87 (1996) 22-27.
[9] J. Patru, Modélisation du développement des contraintes résiduelles au sein de dépôts plasma de zircone et d'acier, Ph.D thesis, Université de Limoges, 2005.
[10] U.S. Pat. No. 5,688,564, Process for the preparation and coating of a surface, C. Coddet & al., INST Polytechnique de Sevenans, IREPA LASER, 1997.
[11] EP-A-0580534, FR-A-2693925, DE-A-69310039, CA-A-2101004, Procédé de preparation et de revêtement de surface et dispositif pour la mise en œeuvre dudit procédé, C. Coddet & al., Institut Polytechnique de Sevenans, IREPA LASER, 1994.
[12] T. Lee, J. Deng, Mechanical surface treatments of electro-discharge machined (EDMed) ceramic composite for improved strength and reliability, Journal of the European Ceramic Society, 22, 2002, 545-550.
[13] M. Verdier, Caractérisation et developpement du procédé PROTAL®, Ph.D thesis, Université de Franche-Comté, 2001.
[14] H Li, S. Costil, S-H. Deng, H-L. Liao, C. Coddet, V. Ji, W-J. Huang, Benefit of surface oxide removal on thermal spray coating adhesion using the PROTAL® process, Proc. International Thermal Spray Conference, May 15-18, 2006, Seattle, Wash., USA.
[15] M. Verdier, G. Montavon, S. Costil, C. Coddet, On the adhesion mechanisms of thermal spray deposits manufactured while implementing the PROTAL® process, Thermal Spray 2001: New Surfaces for a New Millennium, ASM International, Materials Park, Ohio, USA, 2001.
[16] O. Tingaud, A. Bacciochini, G. Montavon, A. Denoirjean, P. Fauchais, Suspension DC plasma spraying of thick finely-structured ceramic coatings: Process manufacturing mechanisms, Surface and Coatings Technology, Volume 203, Issue 15, 2009, 2157-2161.
[17] WO-A1-2006/043006, Revêtement nanostructuré et procédé de revêtement, Wittmann-Tenèze & al., Commissariat à I'Energie Atomique, 2006
[18] WO-A1-2007/090707, Thermal spraying method using a colloidal suspension, R. Sieget & al., Forschungszentrum Juelich GmbH, 2007.
[19] WO-A1-96/06957, Suspension plasma spray deposition, F. Gitzhofer & al., University of Sherbrooke, 1996.
[20] US-A-2008/072790, WO-A-2008/036887, Methods of making a finely structured thermally sprayed coating, J. Roth & al., Inframat Corp., 2008.
[21] K. Wittmann-Ténèze, Etude de I'élaboration de couches minces par projection plasma, PhD thesis, Universite de Limoges, 2001.
[22] C. Delbos, Contribution à la compréhension de I'injection par voie liquide de céramiques (YSZ, Pérovskite, . . . ) ou de métaux (Ni, . . . ) dans un plasma d'arc soufflé afin d'élaborer des dépôts finement structurés pour SOFCs, PhD thesis, Université de Limoges, 2004.
[23] L. Pawlowski, Suspension and solution thermal spray coatings, Surface and Coatings Technology, 203, 2009, 2807-2829.
[24] S. O. Chwo, D. Ricin, F. L. Toma, G. Bertrand, H. Liao, C. Coddet, A. Ohmori, Microstructure and mechanical properties of plasma sprayed nanostructured TiO₂-Al composite coatings, Surface and Coatings Technology, 194 (2005), 215-224.
[25] O. Tingaud, Elaboration de dépôts a gradients de propriétés par projection plasma de suspension de particules sub-micrometriques, PhD thesis, Université de Limoges, 2008.
[26] A. Bacciochini, G. Montavon, A. Denoirjean, P. Fauchais, Porous architecture of SPS Thick Y-PSZ coatings structured at the sub-micrometer scale, Proc. International Thermal Spray Conference, May 4-7, 2009, Las Vegas, Nev., USA.
[27] R. Etchart-Salas, Projection par plasma d'arc de particules submicroniques en suspension. Approche expérimentale et analytique des phénomènes impliqués dans la reproductibilité et la qualité des dépôts, PhD thesis, Université de Limoges, 2007.
[28] On the surface preparation of nickel superalloys before CoNiCrAlY deposition by thermal spray, Surface and Coatings Technology, 184 (2004) 156-162.
[29] US-A-2008/069959, Thermal barrier composition, a superalloy machine part provided with a coating having such a composition, a ceramic coating, and a method of fabricating the coating, B. Leclercq & al., SNECMA, 2008.
[30] U.S. Pat. No. 3,486,927, Process for depositing a protective aluminium coating on metal articles, G. M. C. Gauje, SNECMA, 1969.
[31] JP-A-2007 254883, Method of deposing thermal barrier by plasma torch, F. Braillard, SNECMA, 2007.
[32] US-A-2004/028938, Method of making a protective coating forming a thermal barrier with a bonding underlayer on a superalloy substrate, and a part obtained thereby, B. Saint Ramoud & al., SNECMA MOTEURS, 2004.
[33] US-A-2002/037220, Method of making a protective coating forming a thermal barrier with a bonding underlayer on a superalloy substrate, and a part obtained thereby, B. Saint Ramond & al., SNECMA MOTEURS, 2002.
[34] EP-A-0825275, Procédé de réalisation d'un apport sur une piéce en superalliage á base de nickel ou de cobalt, M.-C. Dumez & al., SNECMA SERVICES, 1998.
[35] U.S. Pat. No. 5,476,723, Coated superalloy component, C. PAGNON, SNECMA, 1995.
[36] IL-A-105821, Process for forming a coating on a superalloy component, and the coated component produced thereby, SNECMA, 1997.
[37] U.S. Pat. No. 6,555,179, Aluminizing process for plasma-sprayed bond coat of a thermal barrier coating system, J. D. Reeves & al., Gen Electric, 2003.
[38] JP-A-2005 126750, Thermal spraying system, I. Yukio, Yamada Kinzokn Boshoku KK; Kyushu Electric Power; I & F Co Ltd, 2005.
[39] EP-A-1980645, Method for applying a multi-layer coating to workpieces and/or work materials, R. Stein & al., 2008.
[40] TW-A-422889, Process for depositing a bond coat for a thermal barrier coating system, Zheng Xiaoci Maggie, Gen Electric, 2001.
[41] JP-A-7 173635, Method for surface treatment of metal, H. Suzuki & al., Suzuki Motor Co, 1995.
[42] JP-A-62 050455, Coating method with ceramic, Y. Takahashi & al., Cosmo Co Ltd, 1987.
[43] US-A-2009/142493, Method of Electrochemically Fabricating Multilayer Structures Having Improved Interlayer Adhesion, A. Cohen & al., 2009.
[44] JP-A-2008/231452, Method for depositing multilayer coating film, S. Kiyozawa & al., Nippon Paint Co Ltd, 2008.
[45] U.S. Pat. No. 4,335,190, Thermal barrier coating system having improved adhesion, R. C. Bill & al., NASA, 1982.
[46] U. Schultz, R. Fritscher, A. Ebach-Stahl, Cyclic behaviour of EB-PVD thermal barrier coating systems with modified bond coats, Surface and Coatings Technology, 203 (2008), 449-455.

1. A method for preparing a thick multilayer coating with a thickness greater than or equal to 100 μm on a surface of a substrate made of a material selected from the group consisting of metals and metal alloys, by at least one thermal spraying method, in which the following successive steps are carried out:
(a) a first nanostructured or finely structured layer of a first material is deposited on the surface of the substrate by a thermal spraying method via a liquid route; the surface of the substrate not having been subject, prior to the deposition of the first nanostructured or finely structured layer, to any preparation or activation treatment other than an optional cleaning treatment;
(b) a second microstructured layer of a second material is deposited on the first nanostructured or finely structured layer by a thermal spraying method via a dry route.

2. (canceled)

3. (canceled)

4. The method according to claim 1, wherein, during step a) the thermal spraying method uses a suspension of nanometric or submicron particles of the first material.

5. The method according to claim 1, wherein, during step a), the thermal spraying method uses a solution of reagents precursors of the first material.

6. The method according to claim 1, wherein the thickness of the first nanostructured or finely structured layer of the first material deposited on the surface of the substrate is greater than the thickness of said first layer in the final multilayer coating obtained at the end of the method.

7. The method according to claim 1, wherein, during step b) the thermal spraying method uses a dry powder of micrometric particles of the second material.

8. The method according to claim 1, wherein the second material has the same composition as the first material and/or the second material has a crystallographic structure close to that of the first material, and/or the second material has a thermomechanical behavior close to that of the first material.

9. The method according to claim 1, wherein after step b), a step c) is carried out during which a third microstructured or nanostructured or finely structured layer of a third material is deposited on the second microstructured layer of the second material by a thermal spraying method.

10. The method according to claim 9, wherein the third material has the same composition as the second material and/or the third material has a crystallographic structure close to that of the second material and/or the third material has a thermomechanical behavior close to that of the second material.

11. The method according to claim 1, wherein the thermal spraying method via a liquid route used in step a) is selected from the group consisting of supersonic or hypersonic spraying methods (HVOF or HVAF), a detonation gun spraying method (D-GUN), and a plasma spraying method.

12. The method according to claim 1, wherein the thermal spraying method used in step b) is a thermal spraying method via a dry route selected from the group consisting of supersonic or hypersonic spraying methods (HVOF or HVAF), a detonation gun spraying method (D GUN), and a plasma spraying method; and further from the flame powder spraying method and the arc wire spraying method.

13. The method according to claim 9, wherein the thermal spraying method used in step c) is either:
a thermal spraying method via a liquid route selected from the group consisting of supersonic or hypersonic spraying methods (HVOF or HVAF), and a plasma spraying method, in the case when the deposited layer during step c) is a nanostructured or finely structured layer; or
(ii) a thermal spraying method via a dry route selected from the group consisting of a supersonic or hypersonic spraying methods (HVOF or HVAF), a detonation gun spraying method (D-GUN), and a plasma spraying methods; and further from the flame powder spraying method and the arc wire spraying method, in the case when the deposited layer during step c) is a microstructured layer.

14. The method according to claim 1, wherein prior to step a), the substrate is preheated and/or prior to step b), the first layer is preheated.

15. The method according to claim 1, wherein the third material is selected independently of the first and second materials and is selected from the group consisting of ceramics, metals and cermets.

16. (canceled)

17. The method of claim 1, wherein the thick multilayer coating has a thickness greater than or equal to 150 μm.

18. The method of claim 11, wherein said supersonic or hypersonic spraying method is a High Velocity Oxy-Fuel method.

19. The method of claim 11, wherein said supersonic or hypersonic spraying method is a High Velocity Air Fuel method.

20. The method of claim 11, wherein said plasma spraying method uses a blown arc or radiofrequency plasma.

21. The method of claim 12, wherein said supersonic or hypersonic spraying method is a High Velocity Oxy-Fuel method.

22. The method of claim 12, wherein said supersonic or hypersonic spraying method is a High Velocity Air Fuel method.

23. The method of claim 12, wherein said plasma spraying method uses a blown arc or radiofrequency plasma.

24. The method of claim 13, wherein said supersonic or hypersonic spraying method is a High Velocity Oxy-Fuel method.

25. The method of claim 13, wherein said supersonic or hypersonic spraying method is a High Velocity Air Fuel method.

26. The method of claim 13, wherein said plasma spraying method uses a blown arc or radiofrequency plasma.

27. The method of claim 15, wherein the ceramics are oxide ceramics.
